(19) United States
(12) Patent Application Publication
(10) Pub. No.: US 2013/0277876 A1
(43) Pub. Date: Oct. 24, 2013

(54) AUTOMATED HARDNESS AND MOISTURE CONTROL IN RAW MATERIAL PROCESSING SYSTEMS

(71) Applicant: Journey Electronics Corp., Monroe, OH (US)

(72) Inventor: Michael Gorden, Monroe, OH (US)

(21) Appl. No.: 13/937,435

(22) Filed: Jul. 9, 2013

Related U.S. Application Data
(62) Division of application No. 12/857,219, filed on Aug. 16, 2010.
Application No. 12/857,219 is a continuation-in-part of application No. 11/609,932, filed on Dec. 13, 2006, now abandoned.
(60) Provisional application No. 60/750,181, filed on Dec. 14, 2005.

(51) Int. Cl. B29C 47/92

(52) U.S. Cl. CPC B29C 47/92
USPC 264/40.4; 264/40.1

(57) ABSTRACT

In accordance with one embodiment of the present invention, a system for controlling the properties of an extrusion from a production line is provided. The production line comprises a raw material feed, a mixer, and an extruder. The control system comprises one or more ammeters electrically coupled to an electrically driven mixing motor and an electrically driven extrusion motor. Output signals indicative of the load amperes I_{M} of the mixing motor and the load amperes I_{X} of the extrusion motor are provided. The controller is in communication with the raw material feed and the ammeter and is programmed to compare the load amperes I_{X} of the extrusion motor to the load amperes I_{M} of the mixing motor and determine whether a result of the load ampere comparison warrants modification of an operating parameter of the production line. If so, the controller modifies one or more operating parameters of the production line to account for the variation from the target value. Additional embodiments are disclosed and claimed.

### CROSS-REFERENCE TO RELATED APPLICATIONS

This application is a division of U.S. patent application Ser. No. 12/857,219 filed Aug. 16, 2010 which is a continuation-in-part of U.S. patent application Ser. No. 11/609,932 filed Dec. 13, 2006 which claims the benefit of U.S. Provisional Application Ser. No. 60/750,181, filed Dec. 14, 2005.

### BACKGROUND OF THE INVENTION

The present invention relates generally to the brick and structural products industry and, more particularly, to systems and processes related to the manufacture of bricks and other structural products from ground clay, shale, or combinations thereof.

For example, and not by way of limitation, the manufacture of brick and other similar structural products generally involves mining, grinding, screening and blending of raw materials followed by forming, cutting or shaping, drying, firing, cooling, storage, and shipping of the final structural product. In a typical brick manufacturing process, the raw materials used in the manufacture of the brick include surface clay and shale, which are commonly mined in open pits. The moisture content of these raw materials ranges from a low of about 3 percent at some plants to a high of about 15 percent at others. Some manufacturing facilities have onsite mining operations, while others bring in raw material by truck or rail. The raw material is typically loaded for processing with a truck or front-end loader into a primary crusher for initial size reduction. The material is then conveyed to a grinding room, which houses several grinding mills and banks of screens that produce a fine material that is suitable for forming brick or other structural products. Types of grinding mills typically used include dry pan grinders, roller mills, and hammermills. From the grinding room, the material is conveyed to storage silos or piles, which typically are enclosed. The material is then either conveyed to the mill room for brick forming or conveyed to a storage area.

Many bricks are formed by what is commonly referred to as a stiff mud extrusion process, although bricks are also formed using the soft mud and dry press processes. A typical stiff mud extrusion line begins with a pug mill, which mixes the ground material with water and discharges the mixture into a vacuum chamber. Some facilities mix additives such as barium carbonate, which prevents sulfates from rising to the surface of the brick, with the raw material prior to extrusion. The moisture content of the material entering the vacuum chamber is typically between 14 and 18 percent. The vacuum chamber removes air from the material, which is then continuously augered or extruded through dies. The resulting continuous “column” is lubricated with oil or other lubricant to reduce friction during extrusion. If specified, various surface treatments, such as manganese dioxide, iron oxide, and iron chromite can be applied at this point. These treatments are used to add color or texture to the product. A wire-cutting machine is used to cut the column into individual bricks, and then the bricks are mechanically or hand set onto kiln cars. All structural tile and most brick are formed by this process. Prior to stacking, some facilities mechanically process the unfired bricks to create rounded imperfect edges that give the appearance of older worn brick.

The soft mud process is usually used with clay that is too wet for stiff mud extrusion. In a pug mill, the clay is mixed with water to a moisture content of 15 to 28 percent, and the bricks are formed in molds and are dried before being mechanically stacked onto kiln cars. In the dry press process, clay is mixed with a small amount of water and formed in steel molds by applying pressure of 500 to 1,500 pounds per square inch (3.43 to 10.28 megapascals).

The present invention is directed towards improving manufacturing processes similar to those described above, where it is important to control the moisture content of raw materials used to form structural products like bricks, tiles, pipes, etc. To this end, the present invention provides systems and methods for controlling the properties of products extruded from production lines. Systems according to the present invention may be installed on existing production lines or provided as an integral part of the production line.

### BRIEF SUMMARY OF THE INVENTION

In accordance with one embodiment of the present invention, a system for controlling the properties of an extrusion from a production line is provided. The production line comprises a raw material feed, a mixer, and an extruder. The control system comprises one or more ammeters electrically coupled to an electrically driven mixing motor and an electrically driven extrusion motor. Output signals indicative of the load amperes I_{M} of the mixing motor and the load amperes I_{X} of the extrusion motor are provided. The controller is in communication with the raw material feed and the ammeter and is programmed to compare the load amperes I_{X} of the extrusion motor to the load amperes I_{M} of the mixing motor and determine whether a result of the load ampere comparison warrants modification of an operating parameter of the production line. If so, the controller modifies one or more operating parameters of the production line to account for the variation from the target value.

In accordance with another embodiment of the present invention, the control system further comprises a scale configured to provide a signal representing the weight of raw material in the raw material feed at a position upstream from the mixer and the extruder. A moisture detector is positioned upstream of the mixer to provide signals representing the moisture content of raw material in the raw material feed. A water supply is positioned to increase the moisture content of the raw material in the raw material feed and a the controller is in communication with the scale, the moisture detector, and the water supply and is programmed to determine the amount of makeup water to be added to the raw material feed from the moisture content signals.

The scale may be configured to provide a signal representing the weight of packets of raw material in the raw material feed. Similarly, the moisture detector may be configured to provide signals representing the moisture content of the packets of raw material. A production monitor provides data representing the position of the packets along the production line and a controller in communication with the scale, the moisture detector, the production monitor, and the water supply is programmed to determine respective amounts of makeup water to be added to individual packets of raw material when the respective packets of interest are in positional registration with the water supply.

In accordance with another embodiment of the present invention, the moisture detector is positioned to provide signals representing the moisture content of the packets of raw material in the raw material feed and the water supply is positioned to increase the moisture content of the raw material in the raw material feed upstream from the mixer and the extruder. An ammeter is electrically coupled to the mixing motor to provide an output signal indicative of the load amperes I_{M} of the mixing motor. A controller in communication with the scale, the moisture detector, the water supply, and the ammeter is programmed to determine respective amounts of makeup water to be added to the raw material feed from the moisture content signals and control the water supply to add the respective amounts of makeup water to the raw material feed. In addition, the controller determines whether the load amperes I_{M} of the mixing motor varies from a target value to an extent sufficient to warrant modification of an operating parameter of the production line and, if warranted, to modify the operating parameter to account for the variation from the target value.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 illustrates a production line and a system for controlling the properties of an extrusion from the production line; and

FIG. 2 is a flow chart illustrating various functional aspects of systems and methods for controlling the properties of an extrusion according to the present invention.

### DETAILED DESCRIPTION

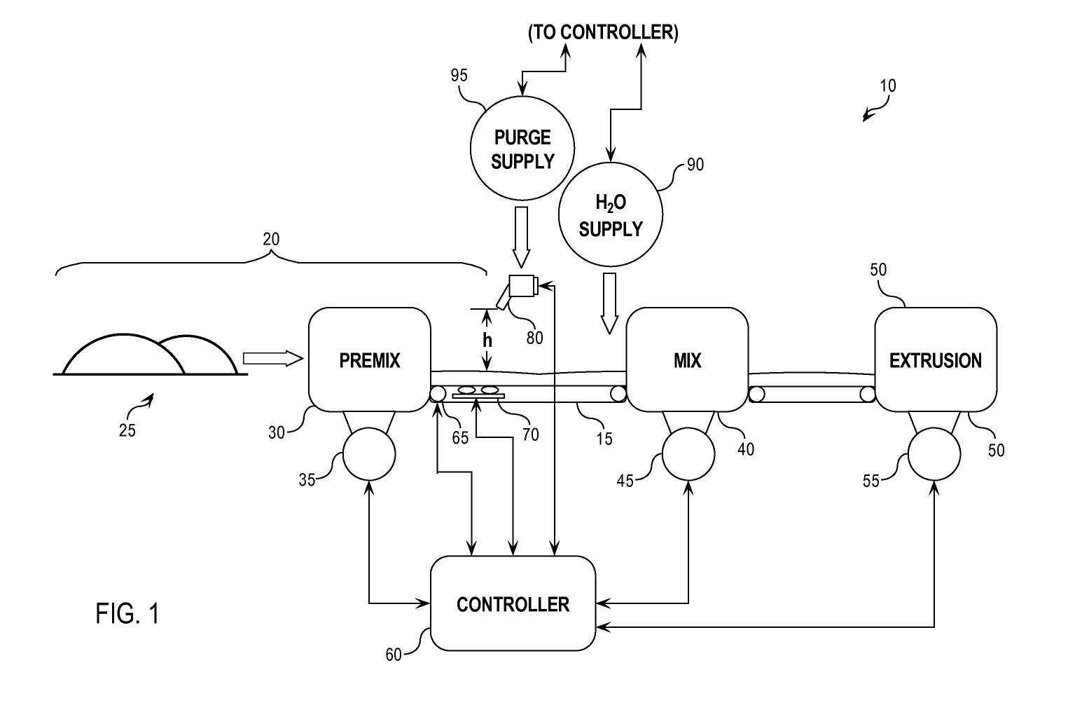

Referring initially to FIG. 1, the various embodiments of the present invention generally relate to systems and methods for controlling the properties of an extrusion from a production line 10 comprising a raw material feed 20, one or more mixers 30, 40, and an extruder 50. Although the raw material feed 20 may include a variety of components configured to direct raw materials to the mixer, in the illustrated embodiment, the raw material feed includes raw materials 25, a pre-mixer 30, and a feed conveyor 15. The feed conveyor 15 is typically an electrically driven conveyor including a controllable conveyor drive mechanism.

In one embodiment, a system for controlling the hardness of a brick extrusion from a production line 10 is provided. The production line 10 comprising a raw material feed 20, a pug mill 30, 40, and a brick extruder 50. The production line 10 may be used to manufacture all sorts of extrudable structures, such as bricks, tile, and other similar items.

Particular embodiments of the present invention are described herein in the context of the manufacture of bricks and other structural products from ground clay, shale, sand, lime, coloring agents, recycled clay or other waste, and combinations thereof. In one embodiment, the raw material feed comprises clay and shale. Other raw material feed compositions are also contemplated. However, it is contemplated that the present invention may be practiced outside this specific context, in other applications where it is necessary to control the properties of an extrusion generated in a production line where raw materials are mixed with water or other additives prior to extrusion.

One embodiment of the present invention relates primarily to the use of signals representing the load amperes in the mixer 40 and the extruder 50 to control hardness in the extruded product. Specifically, the mixer 40 includes an electrically driven mixing motor 45 and the extruder 50 includes an electrically driven extrusion motor 55. According to this embodiment of the present invention, one or more ammeters are coupled to these motors 45, 55 to provide respective output signals indicative of the load amperes I_{M} of the mixing motor 45 and the load amperes I_{X} of the extrusion motor 55. A controller 60 is placed in communication with the raw material feed 20 and the ammeters and is programmed to compare the load amperes I_{X} of the extrusion motor 55 to the load amperes I_{M} of the mixing motor 45. The controller 60 also determine whether the result of the load ampere comparison varies from a target value. For example, the controller 60 may be programmed to calculate the ratio I_{X}/I_{M} and compare the I_{X}/I_{M} ratio to a target value G, representing a predetermined preferred difference between the load on the extrusion motor 55 and the load on the mixing motor 45 for a given extruded hardness. If the comparison, e.g., I_{X}/I_{M}, varies significantly from the target value G, the controller can be programmed to modify an operating parameter of the production line 10 to reduce the difference between the I_{X}/I_{M} ratio and the target value G to at least partially account for the variation of the load ampere comparison from the target value G. Additional detail regarding specific operating parameters to vary is provided below.

In another embodiment, a controller is in dynamic communication with the raw material feed and the ammeter. The controller is programmed to compare the load amperes I_{X} of the extrusion motor to the load amperes I_{M} of the pug mill motor, and determine a load gain factor for the relationship between the pug mill motor and the brick extruder. The target hardness value is a mathematical function of the actual work amps of each (minus the no load amps) and a gain factor between the pug mill and the brick extruder. For example, if the pug mill amperage increases by 10 amps, the brick extruder amps may increase by about 15 amps. In this case, the load gain factor may be 1.5. The hardness determined through the above calculated relationship of pug mill to brick extruder amperes×gain is dynamic, in that it compensates for machine condition and the amount of material being processed at any instant through the system. Since the actual load amps per pack vary constantly depending on the amount of returns from trimmings and scrap, machine operators often make misjudgments in changing makeup water rates by following extruder amperes along. The present inventors have determined that because the extrusion amperes are high, does not necessarily mean that the hardness of the brick is too high, as the pug mill amperes may also be high, and the resultant hardness may be perfect.

The controller may calculate a brick hardness value based on the load ampere comparison and the load gain factor, and compare the calculated hardness value with a target hardness value. The controller may also modify an operating parameter of the production line when warranted to at least partially account for the variation of the calculated hardness value from the target hardness value. The operating parameters may be selected from the makeup water flowrate, the raw material feed rate, and combinations thereof. It is also contemplated that other operating parameters may be adjusted, such as temperatures, mixing rates, and extrusion rates as will be appreciated by one of ordinary skill.

Where the I_{X}/I_{M} ratio is used as the basis for the comparison, it is contemplated that I_{X} and I_{M} can be calculated by using relationships similar to the following equations:

I_{M}=I_{M2}−I_{M1}

I_{X}=I_{X2}−I_{X1}

where I_{M1} represents the amperage of the mixing motor 45 in the absence of a raw material feed, i.e., with no load, I_{M2} represents the amperage of the mixing motor 45 when loaded with raw materials, I_{X1} represents the amperage of the extrusion motor 55 in the absence of a raw material feed, and I_{X2} represents the amperage of the extrusion motor 55 when loaded with raw materials. Alternatively, it is contemplated that the ammeter(s) can be configured to provide an output signal directly proportional to the respective running loads of the mixing motor 45 and the extrusion motor 55 and the controller 60 can be programmed to calculate actual load amps for each mixer from the running load signals and respective no-load amperage signals of the mixers.

Particular target values can be determined in a variety of ways and will vary between specific applications of the present invention. Typically, the target value will be a function of values that represent the primary composition of the raw material feed, the configuration of the mixer, the configuration of the extruder, and combinations thereof. Those practicing the present invention will appreciate that values that represent the composition of the raw material feed, the mixer configuration, and the extruder configuration may be variable and, as such, the controller 60 should be programmed to determine the target value from values that may be variable. For example, where the raw material feed 20 comprises 30% clay and 70% sand, according to one aspect of the present invention, the controller 60 can be programmed to calculate a new target value if the 30/70 ratio changes, if the type of clay or sand in the mixture changes, if recycled material is introduced into the mixture, etc.

As is noted above, the controller 60 is programmed to modify one or more parameters of the raw material feed 20 to at least partially account for the variation of the load ampere comparison from the target value. For example, according to one aspect of the present invention, the controller can be programmed to modify the feed rate of the raw material feed to at least partially account for the variation of the load ampere comparison from the target value. Alternatively, or additionally, the controller 60 can be programmed to modify the amount of moisture added to the raw material feed 20 to at least partially account for the variation of the load ampere comparison from the target value.

The aforementioned load amperage comparison is particularly useful where material changes in the raw material feed are abrupt in nature and relatively drastic. These changes can be caused by severe variations in the mix makeup or, in some cases, by moisture that is hidden deep inside the material particles, undetected by the moisture detector 80. Left uncorrected, variations like these can lead to extruded products that have drastically incorrect hardness.

Because the present inventor has recognized that there is a mathematical relationship between the load amperage of a mixer and extruder. This relationship is often a function of the augers and blades in the pug mill and the auger and extrusion die for the variety of patterns to be extruded. The actual energy put into the material being processed for a properly extruded column is a function of the condition of the machine, the moisture content, and the plasticity of the material being extruded as well as the lubricant pressure applied at the die. If an average target value for extruder amps and an average target value for the pug mill amperage is known for a particular die and mix then a hardness target can be calculated, estimated, or otherwise determined. This target can be adjusted to accommodate for machine wear.

According to one embodiment of the present invention, the target hardness value is taken as a mathematical function of the actual work amps of each mixing motor 45, 55 and a gain factor between the two mixers. For example, if the pug mill amperage increases by 10 amps, then the extruder amps should increase by 15 amps, and the gain factor or target value G will be 1.5. By using these types of target values to define a proper I_{X}/I_{M} ratio, those practicing the present invention will create a dynamic control parameter that compensates for machine condition and the amount of material being processed at any instant through the system. In practicing the present invention, minor changes in moisture set points can be used to compensate for minor changes in the material mix, changes that are often not seen by moisture detectors.

In many cases, systems according to the present invention will comprise a scale 70, a moisture detector 80, and a water supply 90. The scale 70 can be configured to provide a signal representing the weight of raw material in the raw material feed 20 at a position upstream from the mixer 40 and the extruder 50. The moisture detector 80 can be positioned to provide signals representing the moisture content of raw material in the raw material feed at a position upstream from the mixer 40 and the extruder 50. The water supply 90 can be controlled to increase the moisture content of the raw material in the raw material feed 20 upstream from the mixer 40 and the extruder 50. The controller can be placed in communication with the scale 70, the moisture detector 80, and the water supply 90 and can be programmed to determine the amount of makeup water to be added to the raw material feed, using the moisture content signal. Once a suitable amount of makeup water to be added is determined, the controller 60 controls the water supply 90, which may comprise a valve, a spray head, and a digital flow meter, to add the correct amounts of makeup water to the raw material feed. It is contemplated that the water supply 90 may comprise a strainer and an auto-purge mechanism to help ensure that the water supply remains free of debris that could clog the water application mechanism. It is also contemplated that the controller 60 may cooperate with the scale 70 to activate a low dirt level alarm when the signal representing the weight of the raw material falls below a threshold level.

According to one embodiment of the present invention, the system is configured to track packets of raw material along the production line 10 to enable discrete monitoring and control of moisture in the packets. Specifically, it is contemplated that the scale 70 can be configured to provide signals representing the weight of discrete packets of raw material in the raw material feed 20. Similarly, the moisture detector 80 can be configured to provide signals representing the moisture content of the packets of raw material in the raw material feed 20. Further, a production monitor can be configured to provide data representing the position of the packets along the production line 10 and the water supply 90 can be positioned to increase the moisture content of the discrete packets of raw material. The production monitor may take a variety of forms, but in the illustrated embodiment its functionality is embodied in the cooperative relationship between the programmable controller 60, a belt speed indicator 65, and the mixing and extrusion motors 45, 55. Although the present invention is not limited to packets of any particular length, weight, or volume, it is contemplated that packets of about 30 cm would be suitable in many circumstances.

More specifically, the controller 60, which is in communication with the scale 70, the moisture detector 80, the belt speed indicator 65, the mixing motors 45, 55, and the water supply 90, is programmed to determine respective amounts of makeup water to be added to individual ones of the respective packets of raw material in the production line 10. The distinct packets of data representing the respective amounts of makeup water to be added to individual packets of raw material are determined from the moisture content signals for each of the raw material packets. The water supply 90 is controlled to add the respective amounts of makeup water to corresponding ones of the respective packets of raw material when the positional data provided by the production monitor indicates that respective packets of interest are in positional registration with the water supply 90.

The positional data provided by the production monitor can be configured to account for movement of respective raw material packets in the raw material feed 20, the mixer 40, and the extruder 50. Preferably, the positional data is not merely time-based data and accounts for stoppages in the production line. The production monitor can also be configured to cooperate with the controller 60 to generate alarms or disable the water supply 90 and other components of the system when the production data indicates a drop in production below a threshold level.

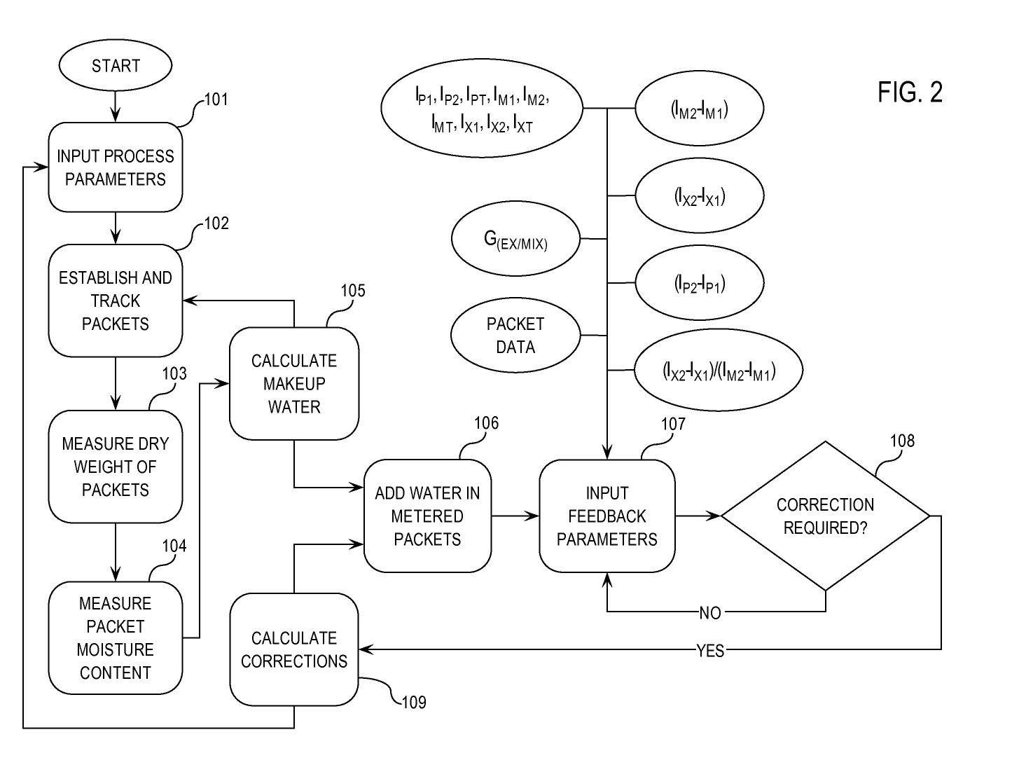

A specific application of the aforementioned packet functionality is illustrated in the flow chart of FIG. 2, where initial process parameters are used to establish and track packets of raw material (see steps 101, 102). It is contemplated that useful initial process parameters will comprise any parameter that has some effect on the position of a packet of raw material in the production line 10 including, but not limited to, system set-up data, the physical properties of the extruded column, the raw material recipe, the properties of the extrusion die, etc.

Once the packets are established, the weight and moisture content of each packet is tracked (see steps 103, 104). This information is used to calculate makeup water to be added to the packets downstream of the moisture detector and weight scale when the packet comes into positional registration with the water supply (see steps 105, 106). As is illustrated in FIG. 2, the system may be configured to provide continuous or nearly continuous creation and tracking of the raw material packets.

The flow chart of FIG. 2 also illustrates one manner in which amperometric load monitoring can be incorporated into an operating scheme of the present invention. Specifically, feedback parameters may be input from a variety of sources including, but not limited to, output signals indicative of the load amperes I_{M} , I_{X} of the mixing and extrusion motors 45, 55 (see step 107). For the purposes of describing and defining the present invention, it is noted that a “signal indicative of load amperes” may be derived from a direct measurement of running amps, a signal proportional to running amps, a signal representing load amps (e.g., by modifying a measured running amp signal), or any of a variety of signals that can be used to determine the load amperes.

Regardless of the specific nature of the amperage signals, the controller 60, which is in communication with the ammeters that provide these signals, is programmed to determine whether the load amperes I_{M} of the mixing motor 45 or the load amperes of the extrusion motor I_{X} vary from corresponding target values (see step 108). If so, the controller can be further programmed to modify one or more operating parameters of the production line 10 to at least partially account for the variation (see step 109). In the illustrated embodiment the correction is implemented by adjusting the amount of water added to the packets of raw material advancing along the production line 10. However, it is contemplated that the other parameters may also be adjusted in response to the feedback analysis. Additional feedback data that may be input at step 107 include, but are not limited to, any data necessary for the aforementioned I_{X}/I_{M} ratio analysis, data input from the pre-mixing motor 35, target values G representing preferred I_{X}/I_{M} ratios for different raw material mixes or extrusion profiles, packet data, process parameters, etc.

For example, the controller 60 can be programmed to cooperate with the moisture detector 80 to detect moisture against a recipe curve for a known mix of raw materials. As the raw material mix changes due to inconsistencies in the raw material preparation process, the controller 60 and moisture detector 80 will read the moisture content incorrectly to a degree that is proportional to the error in the raw material mix. Those practicing the present invention may utilize the aforementioned amperage signals to monitor the plasticity and hardness of the mix in the mixer 40 and/or the extruder 50 to correct for this error. In addition, the aforementioned amperage signals may be utilized to generate warning signals by tracking the position and mass of data packets in the mixers as they pass through the mixers while using amperage signals to determining a shear factor or relative plasticity of the data packets in the either of the mixers. If the shear factor or plasticity measured is correct, then the resultant hardness and final moisture content of the extrusion will also be correct. If the calculated shear factor is low then the final moisture will be too high and the water added per packet must be reduced proportionally. Likewise, if the shear factor is high the final moisture content will be low and the water per packet must be increased to correct the extruded column hardness.

Although a variety of moisture detectors 80 are suitable for use in the context of the present invention, according to one aspect of the present invention, the moisture detector 80 comprises a far-infrared absorption spectrometer and the controller 60 is programmed to cooperate with the spectrometer. More specifically, the controller 60 is programmed to determine moisture content from absorption spectra output from the spectrometer by comparing the absorption spectra with one or more sets of absorption spectra representing a primary composition of the raw material feed. The controller 60 can be programmed to calculate the degree to which the absorption spectra output from the spectrometer varies from the absorption spectra representing the primary composition of the raw material feed. Alternatively, the controller 60 can be programmed to determine moisture content by matching the absorption spectra output from the spectrometer with a stored absorption spectra characterized by a known moisture content.

In specific applications of the present invention, i.e., particularly where the raw material feed defines an irregular advancing vertical profile, it may be advantageous to ensure that the moisture detector is displaced from the raw material feed by at least about 40 cm—a distance particularly well-suited to the detection capabilities of far-infrared spectrometers, particularly those operating at wavelengths in excess of about 15 μm and at bandwidths less than about 0.02 μm. In addition, it is also contemplated that it may be advantageous to provide a filtered air supply configured to purge debris from portions of the optical path of the detector 80, as they may become obstructed by raw material from the production line 10.

Many aspects of the present invention have been described and claimed with reference to a controller that is “programmed to” execute a specific task. For the purpose of describing and defining the present invention it is noted that this language is not intended to imply that the task is optional or not required. Rather, the “programmed to” language limits the structure recited in the claim in that it requires that the recited steps, or equivalents thereof, be performed by the controller, as programmed.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of controlling the properties of a brick extrusion from a production line comprising a raw material feed, a pug mill, and a brick extruder, the method comprising:
utilizing a scale to provide a signal representing the weight of raw material in the raw material feed at a position upstream from the pug mill and the brick extruder;
utilizing a moisture detector to provide signals representing the moisture content of the packets of raw material in the raw material feed at a position upstream from the pug mill and the brick extruder;
utilizing a water supply to increase the moisture content of the raw material in the raw material feed upstream from the pug mill and the brick extruder;
utilizing at least one ammeter electrically coupled to an electrically driven mixing motor of the mixer to provide an output signal indicative of the load amperes I_{M} of the mixing motor;
determining respective amounts of makeup water to be added to the raw material feed from the moisture content signals;
controlling the water supply to add the respective amounts of makeup water to the raw material feed, wherein the raw material feed comprises clay;
determining whether the load amperes I_{M} of the mixing motor vary from a target value to an extent sufficient to warrant modification of an operating parameter of the production line; and
modifying the operating parameter of the production line when warranted to at least partially account for the variation of the load amperes I_{M} of the mixing motor from the target value.

2. A method as claimed in claim 1 wherein the method further comprises:
monitoring an electrically driven mixing motor of the pug mill and an electrically driven extrusion motor of the brick extruder so as to provide an output signal indicative of the load amperes I_{M} of the mixing motor and an output signal indicative of the load amperes I_{X} of the extrusion motor;
comparing the load amperes I_{X} of the extrusion motor to the load amperes I_{M} of the mixing motor;
determining whether a result of the load ampere comparison varies from a target value to an extent sufficient to warrant modification of an operating parameter of the production line, and
modifying the operating parameter of the production line when warranted to at least partially account for the variation of the load ampere comparison from the target value.

3. A method as claimed in claim 1 wherein the method further comprises:
utilizing the scale to provide a signal representing the weight of packets of raw material in the raw material feed at a position upstream from the pug mill and the brick extruder;
utilizing the moisture detector positioned to provide signals representing the moisture content of the packets of raw material in the raw material feed at a position upstream from the pug mill and the brick extruder;
monitoring respective positions of the packets along the production line with a production monitor;
determining respective amounts of makeup water to be added to individual ones of the respective packets of raw material from moisture content signals for each of the packets, and
adding the respective amounts of makeup water to corresponding ones of the respective packets of raw material when respective packets of interest are in positional registration with the water supply.

4. A method as claimed in claim 1 wherein:
the water supply comprises a valve and a flow meter in communication with the controller.

5. A method as claimed in claim 1 wherein the positional data provided by the production monitor accounts for movement of respective raw material packets in the raw material feed, the pug mill, and the brick extruder; and the positional data provided by the production monitor accounts for stoppages in the production line.

6. A method for controlling the hardness of a brick extrusion from a production line comprising a raw material feed, a pug mill, and a brick extruder, and at least one ammeter electrically coupled to an electrically driven mixing motor of the pug mill and an electrically driven extrusion motor of the brick extruder so as to provide an output signal indicative of the load amperes I_{M} of the mill motor and an output signal indicative of the load amperes I_{X} of the extrusion motor, wherein the method comprises:
comparing the load amperes I_{X} of the extrusion motor to the load amperes I_{M} of the mixing motor;
determining a load gain factor representing relative changes in the load amperes I_{M} of the mill motor and the load amperes I_{X} of the extrusion motor for a given set of extrusion conditions;
calculating a brick hardness value based on the load ampere comparison and the load gain factor, wherein the brick hardness value is a mathematical function of the actual work amps of each motor and the load gain factor;
comparing the calculated brick hardness value with a target brick hardness value; and
modifying an operating parameter of the production line when warranted to at least partially account for the variation of the calculated brick hardness value from the target brick hardness value, wherein the operating parameter is selected from makeup water flowrate, raw material feed rate, and combinations thereof, and the raw material feed comprises clay.

7. A method as claimed in claim 6 further comprising:
determining an I_{X}/I_{M} ratio;
calculating the brick hardness value based on the I_{X}/I_{M} ratio and the load gain factor;
comparing the calculated brick hardness value to the target brick hardness value; and
modifying the operating parameter to reduce a difference between the calculated hardness value and the target brick hardness value.

8. A method as claimed in claim 7 further comprising:
determining the I_{X}/I_{M} ratio by using, at least in part, the following equations
I_{M}=I_{M2}−I_{M1}
I_{X}=I_{X2}−I_{X1}
where I_{M1} represents the amperage of the mixing motor in the absence of a raw material feed, I_{M2} represents the amperage of the mixing motor when loaded with a raw material feed, I_{X1} represents the amperage of the extrusion motor in the absence of a raw material feed, and I_{X2} represents the amperage of the extrusion motor when loaded with a raw material feed.

9. A method as claimed in claim 6 wherein:
the ammeter provides an output signal directly proportional to the respective running loads of the mixing motor and the extrusion motor; and
the method comprises calculating actual load amps for each pug mill from the running load signals and respective no-load amperage signals of the pug mills.

10. A method as claimed in claim 6 wherein the target value is a function of one or more values representing a primary composition of the raw material feed, the configuration of the pug mill, the configuration of the brick extruder, and combinations thereof.

11. A method as claimed in claim 6 wherein:
the production line further comprises a scale configured to provide a signal representing the weight of raw material in the raw material feed at a position upstream from the pug mill and the brick extruder, a moisture detector positioned to provide signals representing the moisture content of raw material in the raw material feed at a position upstream from the pug mill and the brick extruder, and a water supply positioned to increase the moisture content of the raw material in the raw material feed upstream from the pug mill and the brick extruder; and
the method comprises determining an amount of makeup water to be added to the raw material feed from the moisture content signals and control the water supply to add the makeup water to the raw material feed.

12. A method as claimed in claim 6 wherein the production line further comprises:
a scale configured to provide a signal representing the weight of packets of raw material in the raw material feed at a position upstream from the pug mill and the brick extruder;
a moisture detector positioned to provide signals representing the moisture content of the packets of raw material in the raw material feed at a position upstream from the pug mill and the brick extruder;
a production monitor configured to provide data representing the position of the packets along the production line; and
a water supply positioned to increase the moisture content of the packets of raw material in the raw material feed upstream from the pug mill and the brick extruder.

13. A method as claimed in claim 12 further comprising:
determining respective amounts of makeup water to be added to individual ones of the respective packets of raw material from moisture content signals for each of the packets, and
controlling the water supply to add the respective amounts of makeup water to corresponding ones of the respective packets of raw material when the positional data provided by the production monitor indicates that respective packets of interest are in positional registration with the water supply.
